(19) United States
(12) Patent Application Publication
(10) Pub. No.: US 2024/0375124 A1
(43) Pub. Date: Nov. 14, 2024

(54) OPENING/CLOSING AND LOCKING MECHANICAL STRUCTURE FOR CENTRIFUGE BIN LID

(71) Applicant: SCINOMED(SHANGHAI)BIO-TECH Co., Ltd., Shanghai (CN)

(72) Inventor: YADONG DONG, Shanghai (CN)

(21) Appl. No.: 18/575,607

(22) PCT Filed: Aug. 2, 2021
(86) PCT No.: PCT/CN2021/109960

§ 371 Date: Dec. 29, 2023

(30) Foreign Application Priority Data
Jul. 1, 2021 (CN) 202110746388.X

(51) Int. Cl. B04B 7/02

(52) U.S. Cl. CPC B04B 7/02; B04B 2007/025

(57) ABSTRACT

An opening/closing and locking mechanical structure for a centrifuge bin lid. The opening/closing and locking mechanical structure comprises a centrifuge bin. The top of the centrifuge bin is provided with a hinge assembly, a bin lid assembly and a lid lock assembly, wherein the hinge assembly and the lid lock assembly are respectively arranged at two ends of the bin lid assembly; the cross-section of the bin lid assembly is equal to the cross-section of the centrifuge bin; and the hinge assembly comprises a lid opening linkage plate, a hinge shaft, a lug seat, pivots, a torsion spring, a torsion spring screw, a protective cover, shoulder bushings, bin-lid pivot damping gaskets, bin-lid bushings, compression nuts, anti-loosening gaskets and circlips.

### TECHNICAL FIELD

The present invention belongs to the technical field of medical instruments, and specifically relates to an opening/closing and locking mechanical structure for a centrifuge bin lid.

### BACKGROUND ART

In the application of medical instruments, especially centrifugal blood processing devices, a centrifuge is required to perform high-speed rotary centrifugation to centrifuge the blood, a centrifuge bin lid is designed on a centrifuge bin in order to prevent safety accidents caused by a high-speed rotating centrifuge rotor and a centrifuge cup being accessed by a person during operation, and in the process of operating the device, it is necessary to frequently open/close and lock the centrifuge bin lid to mount and remove a centrifuge cup consumable.

At present, a design method for a centrifuge bin lid in the centrifugal blood processing device industry is generally as follows: a threaded rotating shaft is used as a rotating shaft of a hinge of the centrifuge bin lid to fix an upper half and a lower half of the hinge, which has no anti-loosening and damping measures, meshing action is realized by installing additional gears at meshing portions of two bin lids separately, and a lid lock assembly is locked by screwing. Due to the unsuitable mechanical structures and materials, it has the following shortcomings: the threaded rotating shaft of the hinge would loosen after a long-term use of the centrifuge bin lid, thereby forming a gap between the upper half and the lower half of the hinge, and during the operation of the centrifuge, the hinge generates a huge harsh noise due to the operation vibration of the centrifuge; and fixing screws of the meshing gears are likely to loosen, causing untight meshing of the bin lids and generating noise when the centrifuge is operating, in addition, due to the structure of the lid lock, during the process of locking the bin lids, a locking nut needs to be screwed at least 5 revolutions to lock the bin lid, resulting in low work efficiency and troubles in use.

### SUMMARY OF THE INVENTION

An objective of the present invention is to provide an opening/closing and locking mechanical structure for a centrifuge bin lid, in order to solve the above problems mentioned in the background art.

To achieve the foregoing objective, the present invention provides the following technical solution: an opening/closing and locking mechanical structure for a centrifuge bin lid, the opening/closing and locking mechanical structure being provided with a centrifuge bin, wherein a hinge assembly, a bin lid assembly and a lid lock assembly are provided at the top of the centrifuge bin; and the hinge assembly and the lid lock assembly are respectively arranged at two ends of the bin lid assembly, and the bin lid assembly has a cross-section equal to that of the centrifuge bin.

Preferably, the hinge assembly comprises a lid opening linkage plate, a hinge shaft, a lug seat, pivots, a torsion spring, a torsion spring screw, a protective cover, shoulder bushings, bin-lid pivot damping gaskets, bin-lid bushings, compression nuts, anti-loosening gaskets and circlips; wherein the lid opening linkage plate is provided with holes for assembling the shoulder bushings, the lid opening linkage plate is connected to the lug seat via the hinge shaft, each of the shoulder bushings is provided with a slot hole for assembling the hinge shaft, the bin-lid bushings are mounted on the pivots, the bin-lid pivot damping gaskets are located on an upper end face and a lower end face of each of the bin-lid bushings respectively, the compression nuts are assembled at upper ends of the bin lid pivots and are located at top ends of the bin-lid pivot damping gaskets, the circlips and the anti-loosening gaskets are both mounted at the top of the compression nuts, the circlips are located at the top of the anti-loosening gaskets, the protective cover covers the compression nuts, the torsion spring is sleeved outside the torsion spring screw, and the torsion spring has two tilting ends.

Preferably, the bin lid assembly comprises symmetrically arranged bin lid frameworks, plexiglass cover plates, a rubber engagement ring, and a locking engagement recess; wherein the plexiglass cover plates are assembled on two sides of the bin lid frameworks, the rubber engagement ring is mounted to top middle portions of the bin lid frameworks, and the locking engagement recess is provided at edge portions of the bin lid frameworks at one end and is connected to the lid lock assembly.

Preferably, a recess for receiving the hinge assembly is formed in the other end of each of the two symmetrically arranged bin lid frameworks, and attachment portions of the two bin lid frameworks at the other end mesh with each other.

Preferably, the lid lock assembly comprises a lid lock handle, a lock rod bushing, a spring, a lid lock copper sleeve and engagement tongues; wherein the engagement tongues are fixed to a bottom edge of the lid lock handle, the lid lock copper sleeve is arranged at the bottom of the lid lock handle, the spring is sleeved on an outer surface of the lid lock copper sleeve, the lock rod bushing is slidably sleeved on the outer surface of the lid lock copper sleeve, and the lock rod bushing is located between the spring and the lid lock handle.

Preferably, the engagement tongues are engaged on inner sides of two ends of the locking engagement recess, and a middle portion of the locking engagement recess is in the shape of a circular hole for the top of the lid lock copper sleeve to pass through.

Compared with the prior art, the present invention has the beneficial effects that
by means of the design of the present invention, various mechanical components are precisely matched, such that shaking is less likely to occur, avoiding the noise of a bin lid caused by the vibration of a centrifuge; a damping device is arranged between a movable component and a relatively fixed component, providing a good movement smoothness; and locking and pressing actions are simple, improving the working efficiency.

### BRIEF DESCRIPTION OF THE DRAWINGS

FIG. 1 is an assembly schematic diagram of the present invention;

FIG. 2 is an assembly schematic diagram of a hinge assembly of the present invention;

FIG. 3 is an overall schematic diagram of a hinge assembly of the present invention;

FIG. 4 is an assembly schematic diagram of a bin lid assembly of the present invention; and

FIG. 5 is an assembly schematic diagram of a lid lock assembly of the present invention.

List of reference signs: 1. centrifuge bin; 2. hinge assembly; 3. bin lid assembly; 4. lid lock assembly; 11. lug seat; 12. hinge shaft; 13. lid opening linkage plate; 14. shoulder bushing; 15. bin-lid pivot damping gasket; 16. bin-lid bushing; 17. compression nut; 18. circlip; 19. anti-loosening gasket; 20. pivot; 21. hinge shaft setscrew; 22. torsion spring; 23. torsion spring screw; 24. protective cover; 30. bin lid framework; 31. plexiglass cover plate; 32. locking engagement recess; 33. rubber engagement ring; 35. lid lock handle; 36. spring; 37. lid lock copper sleeve; 38. lock rod bushing; 39. engagement tongue.

### DETAILED DESCRIPTION OF EMBODIMENTS

The technical solutions in the embodiments of the present invention will be clearly and completely described below with reference to the accompanying drawings in the embodiments of the present invention. Obviously, the embodiments described are merely some rather than all of the embodiments of the present invention. On the basis of the embodiments of the present invention, all other embodiments obtained by those of ordinary skill in the art without involving any inventive effort shall fall within the scope of protection of the present invention.

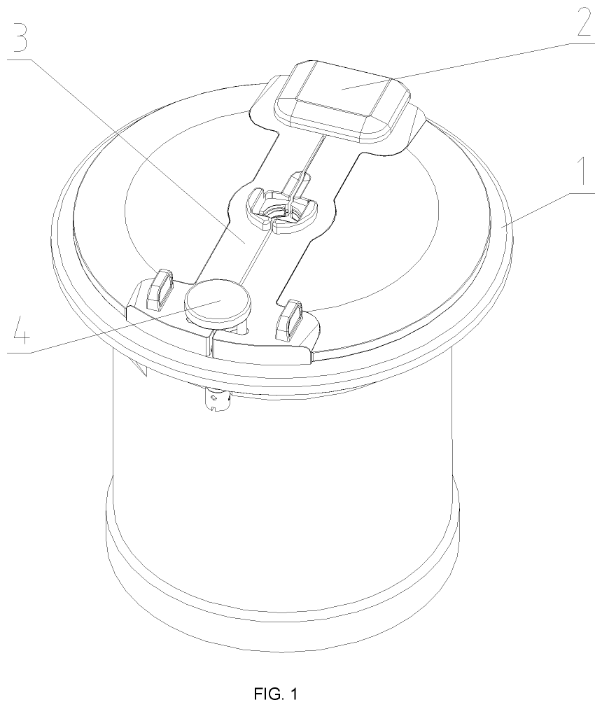

Referring to FIG. 1, the present invention provides a technical solution in which an opening/closing and locking mechanical structure for a centrifuge bin lid is provided with a centrifuge bin 1. A hinge assembly 2, a bin lid assembly 3 and a lid lock assembly 4 are provided at the top of the centrifuge bin 1; and the hinge assembly 2 and the lid lock assembly 4 are respectively arranged at two ends of the bin lid assembly 3, and the bin lid assembly 3 has a cross-section equal to that of the centrifuge bin 1.

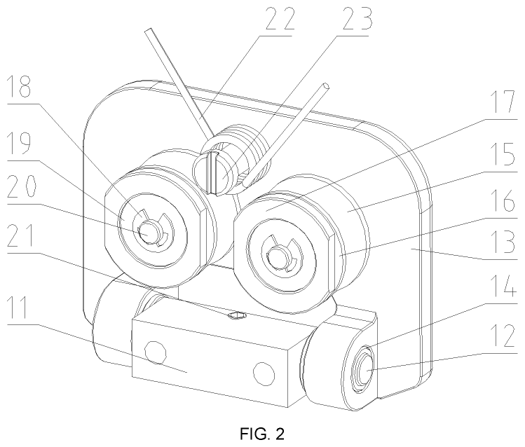

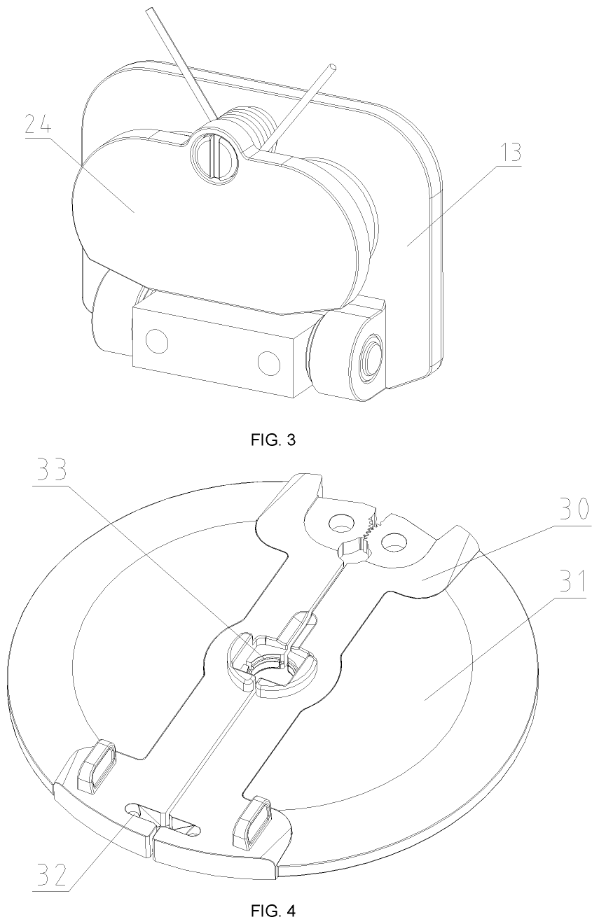

Referring to FIGS. 2 and 3, the hinge assembly 2 comprises a lid opening linkage plate 13, a hinge shaft 12, a lug seat 11, pivots 20, a torsion spring 22, a torsion spring screw 23, a protective cover 24, shoulder bushings 14, bin-lid pivot damping gaskets 15, bin-lid bushings 16, compression nuts 17, anti-loosening gaskets 19 and circlips 18. The hinge shaft 12 is made of stainless steel, the shoulder bushings 14 are made of POM which has the characteristics of smooth surface and high hardness, the shoulder bushings 14 are assembled into and in interference fit with holes of the lid opening linkage plate 13, and the bin-lid pivot damping gaskets 15 are made of polytetrafluoroethylene which has the characteristics of smooth surface and good wear resistance. The lid opening linkage plate 13 is provided with holes for assembling the shoulder bushings 14, the lid opening linkage plate 13 is connected to the lug seat 11 via the hinge shaft 12, each of the shoulder bushings 14 is provided with a slot hole for assembling the hinge shaft 12, the shoulder bushings 14 are in interference fit with the holes in the lid opening linkage plate 13, and the shoulder bushings 14 provide a lubrication function and prevent the hinge shaft 12 from moving radially. The lid opening linkage plate 13 is connected to the lug seat 11 via the hinge shaft 12, and the hinge shaft 12 is pressed tightly by a hinge shaft setscrew 21 after being assembled into the lug seat 11. The bin-lid bushings 16 are mounted on the pivots 20, the bin-lid pivot damping gaskets 15 are located on an upper end face and a lower end face of each of the bin-lid bushings 16 respectively, and the compression nuts 17 are assembled at upper ends of the bin lid pivots 20 and are located at top ends of the bin-lid pivot damping gaskets 15. If the lid opening linkage plate 13 and the lug seat 11 are too tightly assembled, opening/closing would be difficult, and if they are too loosely assembled, noise would be generated during the operation of a centrifuge, so bin-lid pivot damping gaskets 15 are mounted between the lid opening linkage plate 13 and the lug seat 11 for the hinge shaft 12, providing an opening/closing damping function and preventing the lid opening linkage plate 13 from moving axially. When opening/closing bin lids, a smooth friction is formed between the bin lid assembly 3 and the bin-lid bushings 16 due to the effect of the bin-lid bushings 16, in addition, the opening/closing process is smooth and has a damping feel due to the effect of the bin-lid pivot damping gaskets 15. The circlips 18 and the anti-loosening gaskets 19 are both mounted at the top of the compression nuts 17, and the anti-loosening gaskets 19 and the circlips 18 can prevent the compression nuts 17 from loosening. The protective cover 24 is configured to protect the compression nuts 17, and also facilitates the installation of the torsion spring 22. The torsion spring 22 is configured to facilitate opening of the left and right plexiglass cover plates 31 when a lid lock is opened. The circlips 18 are located on the top of the anti-loosening gaskets 19, the protective cover 24 covers the compression nuts 17, the torsion spring 22 is sleeved outside the torsion spring screw 23, and the torsion spring 22 has two tilting ends.

Referring to FIG. 4, the bin lid assembly 3 comprises symmetrically arranged bin lid frameworks 30, plexiglass cover plates 31, a rubber engagement ring 33 and a locking engagement recess 32. The bin lid frameworks 30 are made of stainless steel, the plexiglass cover plates 31 are high-strength transparent plexiglass plates, and the plexiglass cover plates 31 are assembled on two sides of the bin lid frameworks 30. The rubber engagement ring 33 is mounted to top middle portions of the bin lid frameworks 30 to prevent noise caused by the shaking of a centrifuge cup. The locking engagement recess 32 is provided at edge portions of the bin lid frameworks 30 at one end and is connected to the lid lock assembly 4.

In this embodiment, preferably, a recess for receiving the hinge assembly 2 is formed in the other end of each of the two symmetrically arranged bin lid frameworks 30, and attachment portions of the two bin lid frameworks 30 at the other end mesh with each other, preventing the problems of noise and untight closing caused by the loosening of separate gears that are fixed by means of screws.

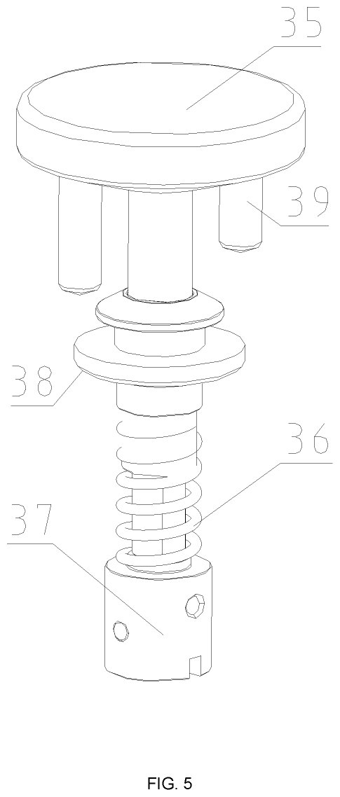

Referring to FIG. 5, the lid lock assembly 4 comprises a lid lock handle 35, a lock rod bushing 38, a spring 36, a lid lock copper sleeve 37 and engagement tongues 39. The lid lock handle 35 is designed with a thread at a lower portion to be in threaded fit with the lid lock copper sleeve 37. The lid lock copper sleeve 37 is made of copper, and the spring 36 is made of piano wire. The engagement tongues 39 are fixed to a bottom edge of the lid lock handle 35, the lid lock copper sleeve 37 is arranged at the bottom of the lid lock handle 35, the spring 36 is sleeved on an outer surface of the lid lock copper sleeve 37, the lock rod bushing 38 is slidably sleeved on the outer surface of the lid lock copper sleeve 37, and the lock rod bushing 38 is located between the spring 36 and the lid lock handle 35. The engagement tongues 39 on the lid lock handle 35 are assembled into the locking engagement recess 32 in the bin lid frameworks 30 to limit and lock the bin lid assembly 3, such that the bin lids cannot be opened, and when the bin lids are required to be opened, the engagement tongues 39 on the lid lock handle 35 are required to be pulled upwardly and separated from the locking engagement recess 32, and then the bin lids can be opened. The lid lock handle 35 would move upwardly when being lifted, with a stroke of 3 mm, the upward movement of the lid lock handle 35 would drive the lid lock copper sleeve 37 at the bottom end to move upwardly, and the lid lock copper sleeve 37 would generate a downward push force due to a reaction force of the spring 36, the push force would eventually be converted into a pressing force on the bin lids, and a top surface of the lid lock bushing 38 is in contact with the interior of the bin lid frameworks 30 to support the bin lid frameworks 30. In a closed state, the bin lid assembly 3 is locked and pressed to achieve double limiting. However, in the process of pulling the lid lock handle 35 and separating the locking engagement tongues 39 from the locking engagement recess 32, only spring-back pressing of the spring 36 does not have an impact on opening.

In this embodiment, preferably, the engagement tongues 39 are engaged on inner sides of two ends of the locking engagement recess 32, and a middle portion of the locking engagement recess 32 is in the shape of a circular hole for the top of the lid lock copper sleeve 37 to pass through.

The operating principle of the present invention is as follows: the lid opening linkage plate 13 is connected to the lug seat 11 via the hinge shaft 12, the hinge shaft 12 is pressed tightly by the hinge shaft setscrew 21, which is in the middle of the lug seat 11, after being assembled into the lug seat 11, the bin-lid pivot damping gaskets 15 are mounted between the lid opening linkage plate 13 and the lug seat 11 for the hinge shaft 12, so as to improve the smoothness of hinge opening/closing and prevent noise, in the process of hinge opening/closing, the lid opening linkage plate 13 and the hinge shaft 12 rotate synchronously, resulting in smooth friction between the hinge shaft 12 and a hinge bushing, in addition, the opening/closing process is smooth and has a damping feel due to the effect of the bin-lid pivot damping gaskets 15, and when the bin lids are closed, the engagement tongues 39 of the lid lock assembly 4 are pressed against the locking engagement recess 32 of the bin lid assembly 3.

Although the embodiments of the present invention have been shown and described, those of ordinary skill in the art may appreciate that various changes, modifications, substitutions, and variations can be made to these embodiments without departing from the principle and spirit of the present invention, and the scope of the present invention is defined by the appended claims and equivalents thereof.

1. An opening/closing and locking mechanical structure for a centrifuge bin lid, the opening/closing and locking mechanical structure being provided with a centrifuge bin, wherein a hinge assembly, a bin lid assembly and a lid lock assembly are provided at the top of the centrifuge bin; and the hinge assembly and the lid lock assembly are respectively arranged at two ends of the bin lid assembly, and the bin lid assembly has a cross-section equal to that of the centrifuge bin.

2. The opening/closing and locking mechanical structure for a centrifuge bin lid according to claim 1, wherein the hinge assembly comprises a lid opening linkage plate, a hinge shaft, a lug seat, pivots, a torsion spring, a torsion spring screw, a protective cover, shoulder bushings, bin-lid pivot damping gaskets, bin-lid bushings, compression nuts, anti-loosening gaskets and circlips; wherein the lid opening linkage plate is provided with holes for assembling the shoulder bushings, the lid opening linkage plate is connected to the lug seat via the hinge shaft, each of the shoulder bushings is provided with a slot hole for assembling the hinge shaft, the bin-lid bushings are mounted on the pivots, the bin-lid pivot damping gaskets are located on an upper end face and a lower end face of each of the bin-lid bushings respectively, the compression nuts are assembled at upper ends of the bin lid pivots and are located at top ends of the bin-lid pivot damping gaskets, the circlips and the anti-loosening gaskets are both mounted at the top of the compression nuts, the circlips are located at the top of the anti-loosening gaskets, the protective cover covers the compression nuts, the torsion spring is sleeved outside the torsion spring screw, and the torsion spring has two tilting ends.

3. The opening/closing and locking mechanical structure for a centrifuge bin lid according to claim 1, wherein the bin lid assembly comprises symmetrically arranged bin lid frameworks, plexiglass cover plates, a rubber engagement ring, and a locking engagement recess; wherein the plexiglass cover plates are assembled on two sides of the bin lid frameworks, the rubber engagement ring is mounted to top middle portions of the bin lid frameworks, and the locking engagement recess is provided at edge portions of the bin lid frameworks at one end and is connected to the lid lock assembly.

4. The opening/closing and locking mechanical structure for a centrifuge bin lid according to claim 3, wherein a recess for receiving the hinge assembly is formed in the other end of each of the two symmetrically arranged bin lid frameworks, and attachment portions of the two bin lid frameworks at the other end mesh with each other.

5. The opening/closing and locking mechanical structure for a centrifuge bin lid according to claim 3, wherein the lid lock assembly comprises a lid lock handle, a lock rod bushing, a spring, a lid lock copper sleeve and engagement tongues; wherein the engagement tongues are fixed to a bottom edge of the lid lock handle, the lid lock copper sleeve is arranged at the bottom of the lid lock handle, the spring is sleeved on an outer surface of the lid lock copper sleeve, the lock rod bushing is slidably sleeved on the outer surface of the lid lock copper sleeve, and the lock rod bushing is located between the spring and the lid lock handle.

6. The opening/closing and locking mechanical structure for a centrifuge bin lid according to claim 5, wherein the engagement tongues are engaged on inner sides of two ends of the locking engagement recess, and a middle portion of the locking engagement recess is in the shape of a circular hole for the top of the lid lock copper sleeve to pass through.
